(19) United States
(12) Patent Application Publication
(10) Pub. No.: US 2016/0254875 A1
(43) Pub. Date: Sep. 1, 2016

(54) Synchronous Time-Division Duplexing Amplifier Architecture

(71) Applicant: Futurewei Technologies, Inc., Plano, TX (US)

(72) Inventor: Sanjay Gupta, Pleasanton, CA (US)

(21) Appl. No.: 15/050,081

(22) Filed: Feb. 22, 2016

Related U.S. Application Data
(60) Provisional application No. 62/121,870, filed on Feb. 27, 2015.

(51) Int. Cl. H04J 3/06; H04B 3/03; H04L 5/14

(52) U.S. Cl. CPC H04J 3/0658; H04L 5/14; H04B 3/03

(57) ABSTRACT

An apparatus comprising a receiver configured to receive a digital subscriber line (DSL) signal carrying a data burst from a first network element (NE) via a first DSL line in a network, a processor coupled to the receiver and configured to perform frame synchronization to determine a burst timing of the data burst, perform signal amplification on the DSL signal to produce an amplified DSL signal, and determine a transmission time for the amplified DSL signal according to the burst timing of the data burst, and a transmitter coupled to the processor configured to transmit the amplified DSL signal to a second NE over a second DSL line in the network according to the transmission time to facilitate communication between the first NE and the second NE.

### CROSS-REFERENCE TO RELATED APPLICATIONS

The present application claims priority to U.S. Provisional Patent Application 62/121,837 filed Feb. 27, 2015 by Sanjay Gupta, and entitled “XDSL Network Amplifier Discovery, Activation, and Management,” and U.S. Provisional Patent Application 62/121,870 filed Feb. 27, 2015 by Sanjay Gupta, and entitled “Synchronous Time-Division Duplexing Amplifier Architecture,” which are incorporated by reference.

### REFERENCE TO A MICROFICHE APPENDIX

Not applicable.

### BACKGROUND

Digital subscriber line (DSL) technologies employ twisted pairs or twisted pair copper cables to carry high-speed broadband data signals over local telephone network. DSL services are delivered simultaneously with wired telephone service or plain old telephone service (POTS) on the same twisted pair. Voice signals or POTS signals are transmitted using frequency bands up to about 4 kilohertz (kHz), whereas DSL signals are transmitted at frequencies above 4 kHz. International Telecommunication Union Telecommunication Sector (ITU-T) defined various DSL standards including asymmetric DSL (ADSL), ADSL2, ADSL2plus, very-high-bit rate DSL (VDSL), and VDSL2, and fast access to subscriber terminals (G.fast) with increasing data rates. The increasing data rates are achieved by employing greater bandwidths and/or advanced signal processing techniques. However, high data rates that approach about 150 megabits per second (Mbps) up to about 1 gigabits per second (Gbps) are only achieved at a very short distance or reach, for example, less than about 500 meters (m).

### SUMMARY

In one embodiment, the disclosure includes an apparatus comprising a receiver configured to receive a digital subscriber line (DSL) signal carrying a data burst from a first network element (NE) via a first DSL line in a network, a processor coupled to the receiver and configured to perform frame synchronization to determine a burst timing of the data burst, perform signal amplification on the DSL signal to produce an amplified DSL signal, and determine a transmission time for the amplified DSL signal according to the burst timing of the data burst, and a transmitter coupled to the processor configured to transmit the amplified DSL signal to a second NE over a second DSL line in the network according to the transmission time to facilitate communication between the first NE and the second NE. In some embodiments, the disclosure also includes the burst timing is associated with a time-domain duplexing (TDD) frame timing of the network, and/or wherein the processor is further configured to obtain configuration information associated with a position of the apparatus in the network, obtain channel information associated with the network, determine an amount of signal amplification according to the configuration information and the channel information, and perform the signal amplification on the DSL signal according to the amount of signal amplification, and/or obtain delay information associated with the apparatus, and determine the transmission time according to the delay information, perform signal conditioning on the DSL signal, and wherein the signal conditioning comprises spectral-shaping, and/or wherein the apparatus is an amplifier positioned along a downstream (DS) transmission path of the network, and wherein the network is a fast access to subscriber terminals (G.fast) network, and/or wherein the apparatus is an amplifier positioned along an upstream (US) transmission path of the network, and wherein the network is a G.fast network, and/or wherein the apparatus is an amplifier, and wherein at least one of the first NE and the second NE is another amplifier.

In another embodiment, the disclosure includes a DSL remote terminal unit comprising a receiver configured to receive a DSL DS signal carrying a DS burst from a DSL office unit via a network, a processor coupled to the receiver and configured to obtain amplifier configuration information associated with at least one amplifier positioned in the network, perform frame synchronization on the DSL DS signal to determine a DS burst timing of the DS burst, determine a first US burst duration for a US burst according to the amplifier configuration information, and determine a first US transmission start time for the US burst according to the DS burst timing, and a transmitter coupled to the processor and configured to transmit the US burst towards the DSL office unit according to the first US transmission start time. In some embodiments, the disclosure also includes wherein the amplifier configuration information indicates a first number of amplifiers along a DS transmission path with a maximum number of amplifiers, wherein Na represents the first number of amplifiers, a second number of amplifiers positioned between the DSL office unit and the DSL remote terminal unit, wherein k represents the second number of amplifiers, and an amplifier delay associated with the amplifiers, wherein T_{apd} represents the amplifier delay, and/or wherein the processor is further configured to obtain a second US burst duration associated with a TDD frame configuration of the network, determine a second US transmission start time according to the DS burst timing and a DS-to-US gap time associated with the DSL remote terminal unit, determine the first US burst duration by reducing the second US burst duration by a first duration of 2×Na×T_{apd}, and determine the first US transmission start time by delaying the second US transmission start time by a second duration of 2×(Na−k)×T_{apd}, and/or obtain a second US burst duration associated with a TDD frame configuration of the network, determine the first US burst duration for the US burst by reducing the second US burst duration by a first duration of 2×k×T_{apd}, determine the first US transmission start time according to the DS burst timing and a DS-to-US gap time associated with the DSL remote terminal unit, and insert a synchronization (S) symbol into the US burst to support US frame synchronization according to Na and T_{apd} so that the S symbol is transmitted at a time of at least 2×(Na−k)×T_{apd} after the first US transmission start time, and/or wherein the network is a G.fast network, wherein the DSL remote terminal unit is a G.fast transceiver unit at a remote terminal side (FTU-R), and wherein the DSL office unit is a G.fast transceiver unit at an office side (FTU-O).

In yet another embodiment, the disclosure includes a DSL office unit comprising a transmitter configured to transmit a DSL DS burst via a first DSL line in a network, a processor coupled to the transmitter and configured to obtain amplifier configuration information associated with at least one amplifier positioned in the network, determine a first US burst start time according to the amplifier configuration information, and determine a first US burst duration according to the amplifier configuration information, and a receiver coupled to the processor and configured to receive a first US burst from a first DSL remote terminal unit according to the first US burst start time and the first US burst duration via the first DSL line. In some embodiments, the disclosure also includes wherein the amplifier configuration information indicates a first number of amplifiers along a DS transmission path with a maximum number of amplifiers, wherein Na represents the first number of amplifiers, a second number of amplifiers positioned between the DSL office unit and the first DSL remote terminal unit, wherein k represents the second number of amplifiers, and an amplifier delay associated with the amplifiers, wherein T_{apd} represents the amplifier delay, and/or wherein the processor is further configured to determine a second US burst duration according to a TDD frame configuration of the network, determine a second US burst start time according to a DS-to-US gap time associated with the DSL office unit, determine the first US burst start time by delaying the second US burst start time by a first duration of 2×Na×T_{apd}, and determine the first US burst duration by reducing the second US burst duration by a second duration of 2×Na×T_{apd}, and/or wherein the processor is further configured to determine a second US burst duration according to a TDD frame configuration of the network, determine a second US burst start time according to a DS-to-US gap time associated with the DSL office unit, determine the first US burst start time by delaying the second US burst start time by a first duration of 2×k×T_{apd}, and determine the first US burst duration by reducing the second US burst duration by a second duration of 2×k×T_{apd}, and/or determine a third US burst start time according to the amplifier configuration information, wherein the third US burst start time is different from the first US burst start time, and determine a third US burst duration according to the amplifier configuration information, wherein the third US burst duration is different from the first US burst duration are different, and wherein the receiver is further configured to receive a second US burst from a second DSL remote terminal unit according to the third US burst start time and the third US burst duration via a second DSL line in the network, and/or wherein the first US burst comprises a first synchronization (S) symbol, wherein the second US burst comprises a second S symbol, and wherein the first S symbol and the second S symbol are received at the same time, and/or wherein the network is a G.fast network, wherein the DSL office unit is a FTU-O, and wherein the DSL remote terminal unit is a FTU-R. For the purpose of clarity, any one of the foregoing embodiments may be combined with any one or more of the other foregoing embodiments to create a new embodiment within the scope of the present disclosure.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram of a G.fast system.

FIG. 2 is a schematic diagram of a TDD frame.

FIG. 3 is a timing diagram illustrating TDD frame timing in a G.fast system.

FIG. 4 is a schematic diagram of a G.fast system that employs synchronous TDD amplifiers according to an embodiment of the disclosure.

FIG. 5 is a schematic diagram of a G.fast system that employs synchronous TDD amplifiers according to another embodiment of the disclosure.

FIG. 6 is a schematic diagram of a NE according to an embodiment of the disclosure.

FIG. 7 is a schematic diagram of a synchronous TDD amplifier according to an embodiment of the disclosure.

FIG. 8 is a timing diagram illustrating a regular transmission scheme according to an embodiment of the disclosure.

FIG. 9 is a timing diagram illustrating an efficient transmission scheme according to an embodiment of the disclosure.

FIG. 10 is a flowchart of a signal amplification method according to an embodiment of the disclosure.

FIG. 11 is a flowchart of a US transmission method according to an embodiment of the disclosure.

FIG. 12 is a flowchart of a US transmission method according to another embodiment of the disclosure.

FIG. 13 is a flowchart of a US transmission method according to another embodiment of the disclosure.

FIG. 14 is a flowchart of a US reception method according to an embodiment of the disclosure.

FIG. 15 is a flowchart of a US reception method according to another embodiment of the disclosure.

### DETAILED DESCRIPTION

It should be understood at the outset that although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

The various ITU-T DSL standards such as the ADSL, the ADSL2, ADSL2plus, VDSL, VDSL2, and G.fast standards are deployed between a central office (CO) or a distribution point (DP) and customer premises. Data are modulated using discrete multi-tone (DMT) modulation and transmitted using digital baseband transmission. The ADSL, ADSL2, ADSL2+, VDSL, and VDSL2+ standards employ frequency-domain duplexing (FDD), where US transmission and DS transmission occur simultaneously at two different frequency bands, such as via an uplink (UL) or a downlink (DL). US refers to the transmission direction from a customer premise equipment (CPE) to a CO, whereas DS refers to the transmission direction from a CO to a CPE. The G.fast standard employs TDD, where US transmission and DS transmission occupy the same frequency band, but occur at different time intervals. The G.fast standard is described in ITU-T documents G.9700 and G.9701, which are incorporated by reference.

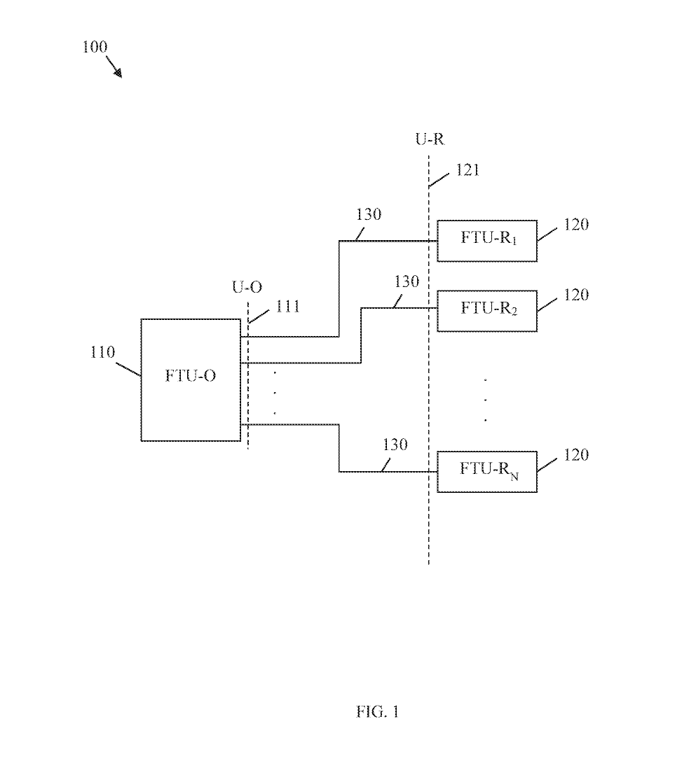

FIG. 1 is a schematic diagram of a G.fast system 100. The system 100 comprises a FTU-O 110 and a plurality of FTU-Rs 120 interconnected by a plurality of twisted pair lines 130. The twisted pair lines 130 comprise two conductors of a single circuit twisted together for the purpose of electromagnetic interference (EMI) cancellation. The FTU-O 110 is located at a CO or a distribution point unit (DPU), which is connected to a backbone network such as the Internet via one or more intermediate networks, which may include an optical distribution network (ODN). The FTU-Rs 120 are located at customer premises and may be further connected to devices such as routers and computers. Thus, the FTU-O 110 and the FTU-Rs 120 are also referred to as a DSL office unit and DSL remote terminal units, respectively. The FTU-O 110 comprises a U-O interface 111 facing the remote terminal side of the twisted pair lines 130. The FTU-Rs 120 comprise U-R interfaces 121 facing the office side of the twisted pair lines 130. The system 100 is suitable for deployment in a Fiber-to-the-Distribution-Point (FTTdp) environment.

The FTU-O 110 may be any device configured to communicate with the FTU-Rs 120. The FTU-O 110 functions as a DSL access multiplexer (DSLAM), which terminates and aggregates DSL signals from the FTU-Rs 120 and handed off to other network transports. In a DS direction, the FTU-O 110 forwards data received from a backbone network to the FTU-Rs 120. In a US direction, the FTU-O 110 forwards data received from the FTU-Rs 120 onto the backbone network. Although the specific configuration of the FTU-O 110 may vary, the FTU-O 110 may comprise a transmitter and a receiver configured to transmit and receive signals over the twisted pair lines 130. The FTU-O 110 may further comprise other functional units for performing physical (PHY) layer signal processing, open system interconnection (OSI) model layer 2 (L2) and above (L2+) processing, activations of the FTU-Rs 120, resource allocation, and other functions associated with the management of the system 100.

The FTU-Rs 120 may be any devices configured to communicate with the FTU-O 110. The FTU-Rs 120 act as intermediaries between the FTU-O 110 and connected devices to provide Internet access to the connected devices. In a DS direction, the FTU-Rs 120 forward data received from the FTU-O 110 to corresponding connected devices. In a US direction, the FTU-Rs 120 forward data received from the connected devices to the FTU-O 110. Although the specific configuration of the FTU-Rs 120 may vary, the FTU-Rs 120 may comprise transmitters and receivers configured to transmit and receive signals over the twisted pair lines 130. The FTU-Rs 120 may further comprise other functional units for performing PHY layer processing, L2+ processing, and other management related functions.

In operation, the FTU-O 110 and FTU-Rs 120 exchange messages and negotiations in various initialization stages to complete the activation of the FTU-Rs 120. For example, the messages may include capabilities and mode of operations of the FTU-O 110 and the FTU-Rs 120. During initialization, the FTU-O 110 and the FTU-Rs 120 may perform channel measurement and analysis, which may be used for subsequent resource allocation. After completing the initialization, the FTU-O 110 and the FTU-Rs 120 enter a showtime stage or a normal operation stage, where the FTU-O 110 and the FTU-Rs 120 exchange data. The FTU-O 110 and the FTU-Rs 120 transmit and receive signals using TDD, as described more fully below.

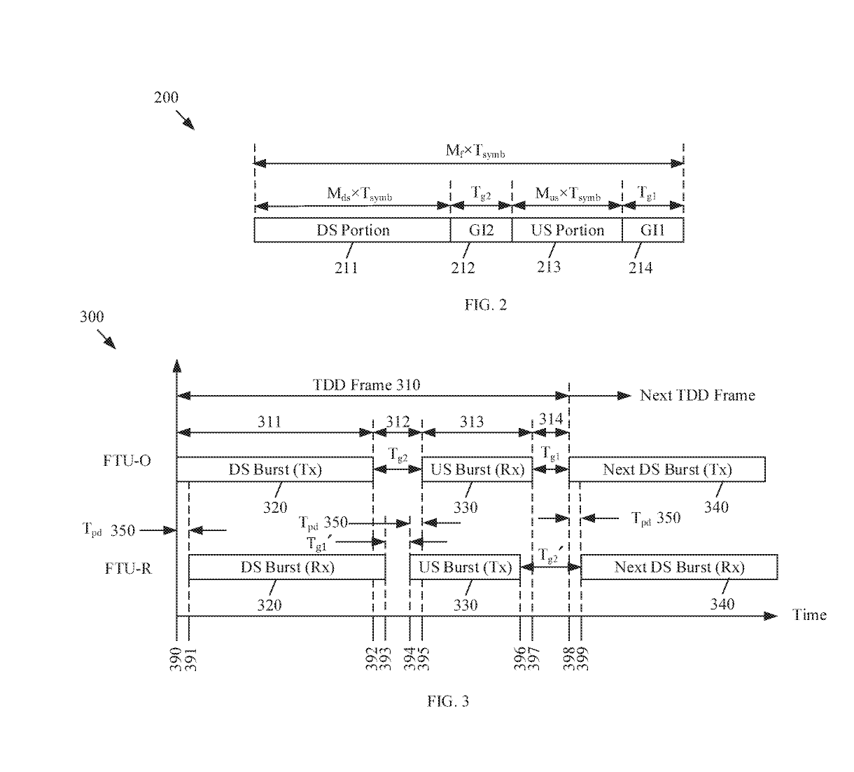

FIG. 2 is a schematic diagram of a TDD frame 200 as described in the ITU-T document G.9701. The TDD frame 200 is employed by the FTU-O 110 and the FTU-Rs 120 for transmission and reception. The TDD frame 200 comprises a DS portion 211, a DS-to-US gap time 212, an US portion 213, and a US-to-DS gap time 214. The DS-to-US gap time 212 is positioned between the US portion 213 and the DS portion 211. The US-to-DS gap time 214 is positioned at the end of the TDD frame 200. In operation, multiple TDD frames similar to the TDD frame 200 are concatenated to form a super frame. The TDD frame 200 comprises an integer number of symbols, shown as M_{f}. The DS portion 211 comprises an integer number of symbols, shown as M_{ds}. The US portion 213 comprises an integer number of symbols, shown as Mᵤₛ. The TDD frame 200 spans a time interval of M_{f}×T_{symb}. T_{symb} represents a DMT symbol time including cyclic extension. The duration of the DMT symbol time depends on network parameters such as sampling rates, fast Fourier transform (FFT)/inverse FFT (IFFT) sizes, and cyclic extension length. The DS portion 211 spans a time interval of M_{ds}×T_{symb}, and the US portion 213 spans a time interval of Mᵤₛ×T_{symb}. The DS-to-US gap time 212 spans a time interval of T_{g2} and the US-to-DS gap time 214 spans a time interval of T_{g1}, where the sum of T_{g1} and T_{g2} equals to one DMT symbol time. The DS portion 211 is used for carrying a DS burst transmitted by an FTU-O. The US portion 213 is used for carrying a US burst transmitted by an FTU-R.

FIG. 3 is a timing diagram illustrating TDD frame timing 300 in a G.fast system such as the system 100. The TDD frame timing 300 is as described in the ITU-T document G.9701. The TDD frame timing 300 illustrates transmit and receive timings of a TDD frame 310 similar to the TDD frame 200. The TDD frame 310 carries a DS burst 320 and a US burst 330. The DS burst 320 is transmitted by an FTU-O such as the FTU-O 110. The US burst 330 is transmitted by an FTU-R such as the FTU-R 120. It should be noted that in a G.fast system, all FTU-Rs reference the timings of an FTU-O. For example, the TDD frame 310 comprises a DS portion 311 starting at time 390, a DS-to-US gap time 312 starting at time 392, a US portion 313 starting at time 395, and a US-to-DS gap time 314 starting at time 397. The DS portion 311, the DS-to-US gap time 312, the US portion 313, and the US-to-DS gap time 314 are similar to the DS portion 211, the DS-to-US gap time 212, the US portion 213, and the US-to-DS gap time 214, respectively. A next TDD frame similar to the TDD frame 310 may begin at a time 398 when the US-to-DS gap time 314 elapsed.

As shown, at time 390, the FTU-O transmits the DS burst 320 to the FTU-R, shown as DS Burst transmit (Tx). At time 391, after a propagation delay 350, shown as T_{pd}, the DS burst (Tx) 320 arrives at the FTU-R, shown as DS Burst receive (Rx). At time 394, the FTU-R transmits the US burst 330 to the FTU-O, shown as US Burst (Tx), at an earlier time than the start time of the US portion 313 to account for the propagation delay 350. At time 395, after the propagation delay 350, the US burst (Tx) 330 arrives at the FTU-O, shown as US Burst (Rx), where the time 395 corresponds to the start time of the US portion 313 at the FTU-O. Since the FTU-R transmits the US burst (Tx) 330 at an earlier time, the duration (e.g., T_{g1′}) between the time 393 when the reception of the DS burst (Rx) 320 is completed and the time 394 when the transmission of the US burst (Tx) 330 is started at the FTU-R is shorter than the duration (e.g., T_{g2}) of the DS-to-US gap time 312 at the FTU-O.

At time 398, after the US-to-DS gap time 314 elapsed, the FTU-O transmits a next DS burst 340 to the FTU-R, shown as Next DS Burst (Tx). At time 399, after a propagation delay 350, the next DS burst (Tx) 340 arrives at the FTU-R. The duration (e.g., T_{g1′}) between the time 396 when the transmission of the US burst (Tx) 330 is completed and the time 399 when the next DS burst (Rx) 340 is received is longer than the duration (e.g., T_{g1}) of the US-to-DS gap time 314 at the FTU-O.

The G.fast standard is developed to target high speed performance. However, the reach for G.fast is limited. One approach to extending the reach is to add analog amplifiers between an FTU-O such as the FTU-O 110 and FTU-Rs such as the FTU-R 120 to amplify DS signals transmitted from the FTU-O and to amplify US signals transmitted from the FTU-Rs. Analog amplifiers may be easily added in an FDD system since US and DS transmission are separated by frequency bands instead of time. However, in a TDD system such as the system 100, US and DS burst timings are more restricted as shown in the TDD frame timing 300. For example, the ITU-T document G.9701 specifies a minimum total duration of 6.5 microseconds (μs) for both T_{g1} and T_{g2} and a maximum duration of 4.5 μs for T_{pd} based on a symbol time of 20.8 μs. In order to employ analog amplifiers in the system 100, the analog amplifiers are required to meet a round trip delay of less than about 3.3 μs, which is computed by subtracting T_{g1}, T_{g2}, and T_{pd} from T_{symb}. Thus, it may be difficult to simply add analog amplifiers into the TDD-based G.fast system to extend reach or increase coverage.

Disclosed herein are various embodiments for increasing G.fast network coverage by employing a synchronous TDD amplifier network. In a G.fast network, one or more digital amplifiers are added between an FTU-O and FTU-Rs. The amplifiers are arranged in a cascade configuration or a tree configuration. The amplifiers perform TDD frame synchronization, signal amplification, and other signal conditioning functions. To achieve synchronous transmissions, the FTU-Rs adjust US transmission start time and US burst duration according to the number of amplifiers between the FTU-O and corresponding FTU-Rs, the maximum number of amplifiers in a transmission path, and delays of the amplifiers. In a regular transmission scheme, all FTU-Rs shorten US burst durations to accommodate the worst amplifier delay incurred by the transmission path with the maximum number of amplifiers and delay US transmissions. The regular transmission scheme reduces the data rates of FTU-Rs that are directly connected to the FTU-O, but significantly increases the data rates or the reach of FTU-Rs that are connected to the FTU-O via amplifiers. In an efficient transmission scheme, FTU-Rs shorten US burst durations to accommodate delays of amplifiers positioned between the FTU-O and corresponding FTU-Rs without delaying US transmissions. The efficient transmission scheme maintains the data rates of FTU-Rs that are directly connected to the FTU-O and significantly increases the data rates or the reach of FTU-Rs that are connected to the FTU-O via amplifiers. However, when employing the efficient transmission scheme, the positions of G.fast synchronization (S) symbol in a US burst are configured according to the number of amplifiers between the FTU-O and corresponding FTU-Rs so that the S symbols of all US bursts arrive at the FTU-O at the same time. Thus, the disclosed embodiments are suitable for use in conjunction with vectoring to mitigate or cancel crosstalk, where vectoring operates on a group of DSL lines requiring synchronous US transmissions.

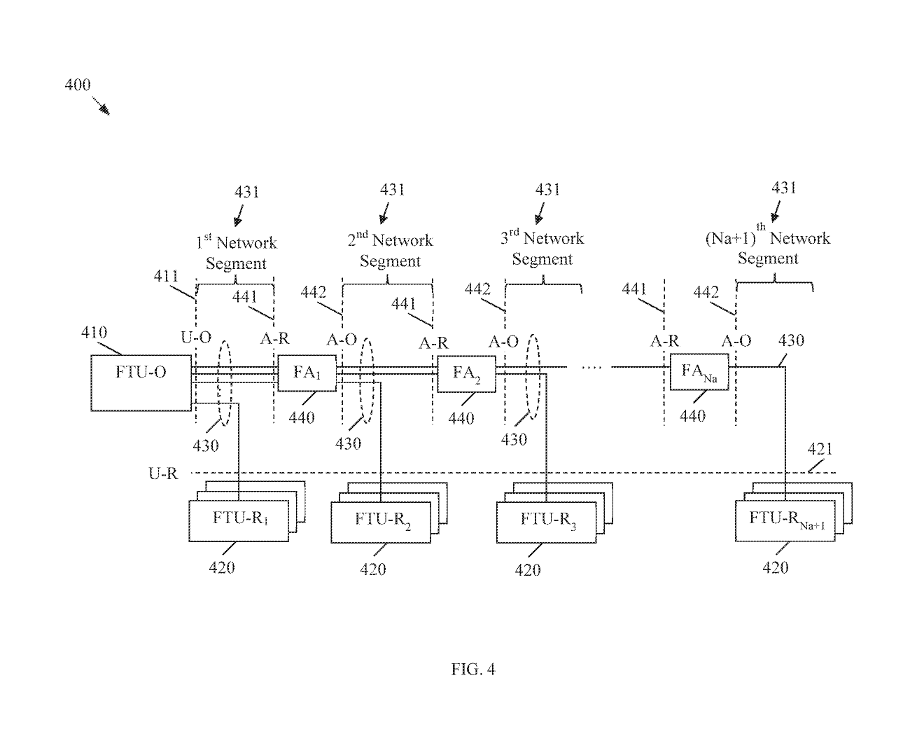

FIG. 4 is a schematic diagram of a G.fast system 400 that employs synchronous TDD amplifiers 440 according to an embodiment of the disclosure. The system 400 is similar to the system 100, but the employment of the amplifiers 440 increases coverage and/or data rates in the system 400. The system 400 comprises an FTU-O 410 connected to a plurality of FTU-Rs 420, shown as FTU-R₁ to FTU-R_{Na+1}, positioned in a plurality of network segments 431 via one or more of the amplifiers 440, shown as FA₁ to FA_{Na}, arranged in a cascade configuration. Na represents the number of amplifiers 440 cascaded in the system 400. The FTU-O 410, the amplifiers 440, and the FTU-Rs 420 are interconnected by a plurality of twisted pair lines 430. The FTU-O 410, the FTU-Rs 420, and the twisted pair lines 430 are similar to the FTU-O 110, the FTU-Rs 120, and the twisted pair lines 130, respectively. As shown, the FTU-R₁s 420 in the first network segment 431 are directly connected to the FTU-O 410, the FTU-R₂s 420 in the second network segment 431 are connected to the FTU-O 410 via one amplifier 440, the FTU-R₃s 420 in the third network segment 431 are connected to the FTU-O 410 via a cascade of two amplifiers 440, and the FTU-R_{Na+1}s 420 in the (Na+1)^{th} network segment 431 are connected to the FTU-O 410 via a cascade of Na+1 number of amplifiers 440. Similar to the system 100, the FTU-O 410 comprise a U-O interface 411 similar to the U-O interface 111 facing the remote terminal side of the twisted pair lines 430 and the FTU-Rs 420 comprise U-R interfaces 421 similar to the U-R interfaces 121 facing the office side of the twisted pair lines 430. Similarly, the amplifiers 440 comprise A-R interfaces 441 facing the office side of the twisted pair lines 430 and A-O interfaces 442 facing the remote terminal side of the twisted pair lines 430.

The amplifiers 440 may be any devices configured to perform signal amplification through analog and/or digital signal processing, as described more fully below. In a DS direction, the amplifiers 440 amplify DS signals received from the FTU-O 410 and transmit the amplified DS signals to the FTU-Rs 420. The spectral masks of the transmitted amplified DS signals at the A-O interfaces 442 are compliant with the spectral masks defined for the U-O interface 411 in ITU-T document G.9701. In a US direction, the amplifiers 440 amplify US signals received from the FTU-Rs 420 and transmit the amplified US signals to the FTU-O 410. The spectral masks of the transmitted amplified US signals at the A-R interfaces 441 are compliant with the spectral masks and US power back-off (UPBO) requirements defined for the U-R interface 421 in ITU-T document G.9701. By amplifying the US signals and the DS signals, the FTU-Rs 420 may be positioned further away from the FTU-O 410, yet maintain a high speed connection, as described more fully below.

The addition of the amplifiers 440 to the system 400 introduces additional delays in the US and DS transmission paths. In order to maintain the TDD frame timing such as the TDD frame timing 300, the amplifiers 440 buffer TDD frames and re-synchronize to the TDD frame timing, and the FTU-O 410 and the FTU-Rs 420 adjust the start time and/or the end time of the US and DS transmissions, as described more fully below.

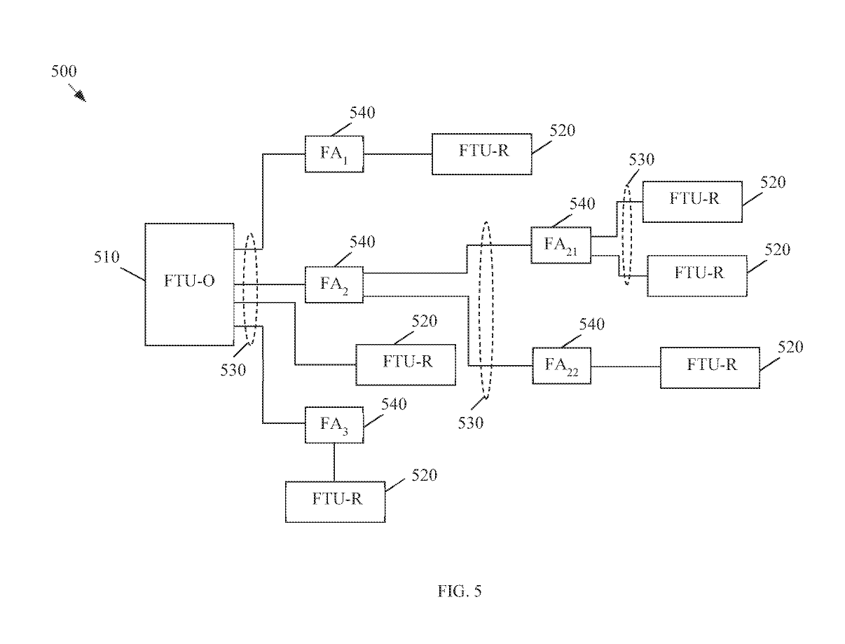

FIG. 5 is a schematic diagram of a G.fast system 500 that employs synchronous TDD amplifiers 440 according to another embodiment of the disclosure. The system 500 is similar to the system 400, but illustrates the employment of amplifiers 540 in a tree configuration instead of a cascade configuration. The system 500 comprises an FTU-O 510, a plurality of FTU-Rs 520, and the amplifiers 540 interconnected by a plurality of twisted pair lines 530 and arranged in a tree configuration. The FTU-O 510 is similar to the FTU-Os 110 and 410. The FTU-Rs 520 are similar to the FTU-Rs 120 and 420. The twisted pair lines 530 are similar to the twisted pair lines 130 and 430. The amplifiers 540 are similar to the amplifiers 440. The amplifiers 540 are shown as FA₁, FA₂, FA₃, FA₂₁, and FA₂₂. The amplifiers FA₁, FA₂, and FA₃ 540 are directly connected to the FTU-O 510, whereas the amplifiers FA₂₁ and FA₂₂ 540 are connected to the FTU-O 510 via the amplifier FA₂ 540.

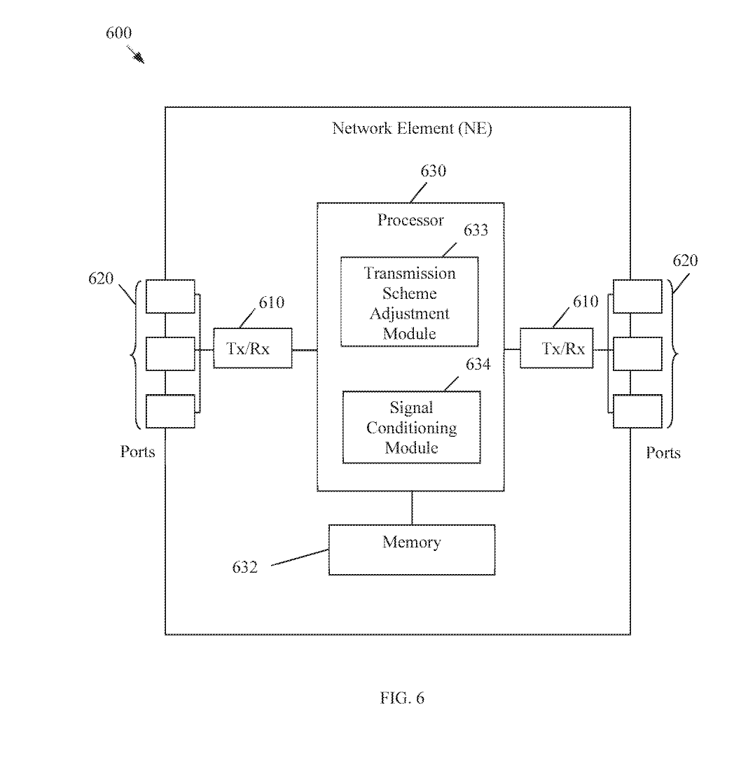

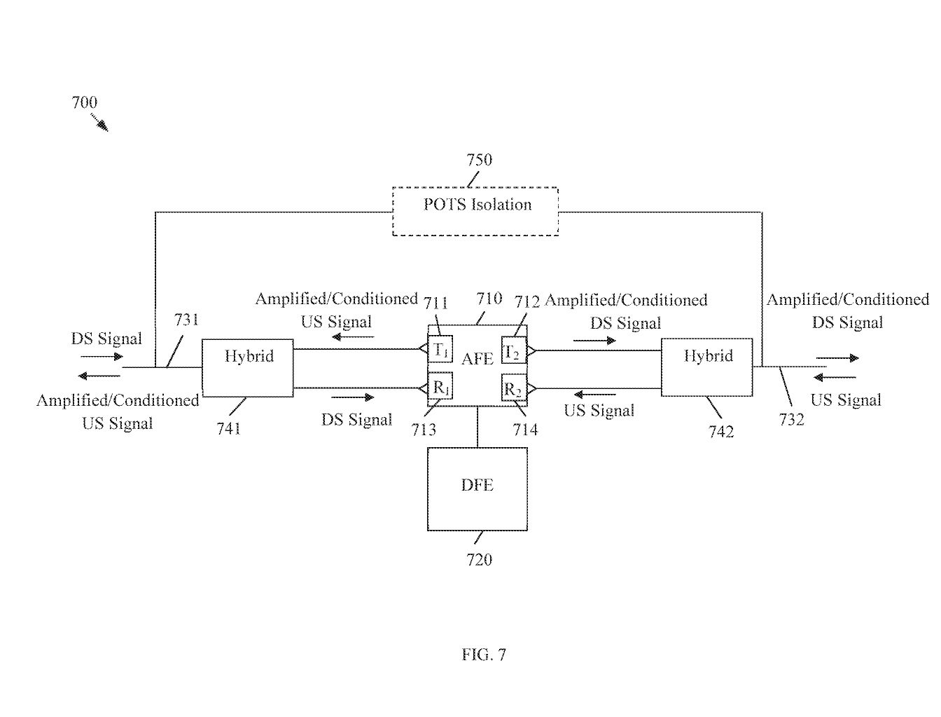

FIG. 6 is a schematic diagram of an NE 600 according to an embodiment of the disclosure. The NE 600 may be an FTU-O such as the FTU-Os 410 and 510, an FTU-R such as the FTU-Rs 420 and 520, or an amplifier such as the amplifiers 440 and 540, in a network such as the systems 400 and 500, depending on the embodiments. NE 600 may be configured to implement and/or support the transmission scheme adjustment and signal conditioning mechanisms and schemes described herein. NE 600 may be implemented in a single node or the functionality of NE 600 may be implemented in a plurality of nodes. One skilled in the art will recognize that the term NE encompasses a broad range of devices of which NE 600 is merely an example. NE 600 is included for purposes of clarity of discussion, but is in no way meant to limit the application of the present disclosure to a particular NE embodiment or class of NE embodiments.

At least some of the features/methods described in the disclosure are implemented in a network apparatus or component, such as an NE 600. For instance, the features/methods in the disclosure may be implemented using hardware, firmware, and/or software installed to run on hardware. The NE 600 is any device that transports packets through a network, e.g., a switch, router, bridge, server, a client, etc. As shown in FIG. 6, the NE 600 comprises transceivers (Tx/Rx) 610, which may be transmitters, receivers, or combinations thereof. The Tx/Rx 610 is coupled to a plurality of ports 620 for transmitting and/or receiving frames from other nodes.

A processor 630 is coupled to each Tx/Rx 610 to process the frames and/or determine which nodes to send the frames to. The processor 630 may comprise one or more multi-core processors and/or memory devices 632, which may function as data stores, buffers, etc. The processor 630 may be implemented as a general processor or may be part of one or more application specific integrated circuits (ASICs) and/or digital signal processors (DSPs). The processor 630 may comprise a transmission scheme adjustment module 633 and a signal conditioning module 634.

The transmission scheme adjustment module 633 implements transmission scheme adjustment as described in the schemes 800 and 900 and the methods 1000, 1100, 1200, 1300, 1400, and 1500, as discussed more fully below, and/or any other flowcharts, schemes, and methods discussed herein. The signal conditioning module 634 implements signal conditioning as described in the amplifier 700, the schemes 800 and 900, and the method 1000, as discussed more fully below, and/or any other flowcharts, schemes, and methods discussed herein. As such, the inclusion of the transmission scheme adjustment module 633 and the signal conditioning module 634 and associated methods and systems provide improvements to the functionality of the NE 600. Further, the transmission scheme adjustment module 633 and the signal conditioning module 634 effect a transformation of a particular article (e.g., the network) to a different state. In an alternative embodiment, the transmission scheme adjustment module 633 and the signal conditioning module 634 may be implemented as instructions stored in the memory device 632, which may be executed by the processor 630.

The memory 632 comprises one or more disks, tape drives, and solid-state drives and may be used as an over-flow data storage device, to store programs when such programs are selected for execution, and to store instructions and data that are read during program execution. The memory 632 may be volatile and non-volatile and may be read-only memory (ROM), random-access memory (RAM), ternary content-addressable memory (TCAM), and static random-access memory (SRAM).

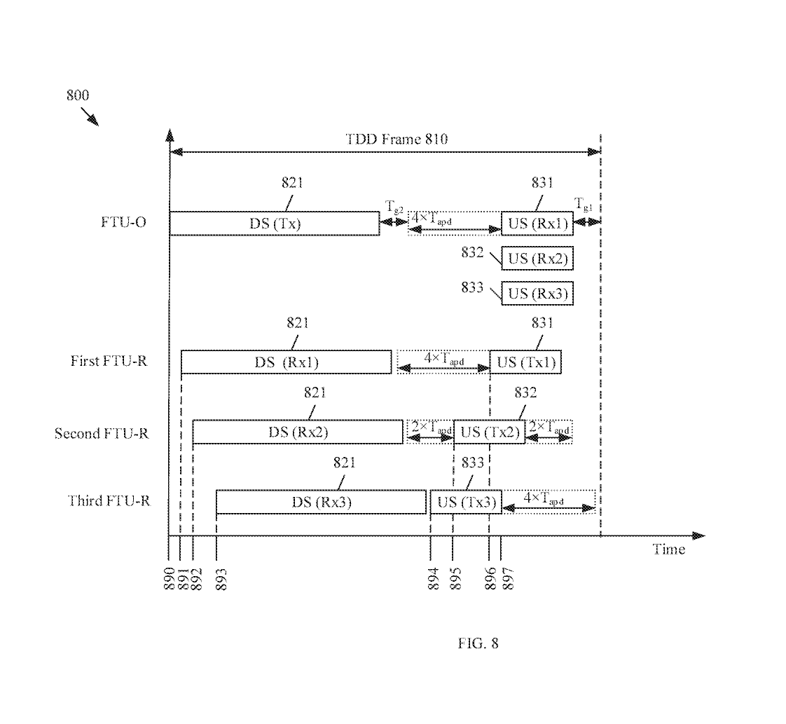

FIG. 7 is a schematic diagram of a synchronous TDD amplifier 700 according to an embodiment of the disclosure. The amplifier 700 is employed by the systems 400 and 500. The amplifier 700 is similar to the amplifiers 440 and 540 and provides a more detailed view of the amplifiers 440 and 540. The amplifier 700 comprises an analog frontend (AFE) unit 710 coupled to a digital frontend (DFE) unit 720. The AFE unit 710 comprises a first transmit port 711 shown as T₁, a second transmit port 712 shown as T₂, a first receive port 713 shown as R₁, and a second receive port 714 shown as R₂. The first transmit port 711 and the first receive port 713 are coupled to a first hybrid 741, which is coupled to a first twisted pair line 731. The second transmit port 712 and the second receive port 714 are coupled to a second hybrid 742, which is coupled to a second twisted pair line 732. The first twisted pair line 731 and the second twisted pair line 732 are similar to the twisted pair lines 130, 430, and 530. The first hybrid 741 and the second hybrid 742 comprise circuit components configured to suppress at least some amount of echoes between transmit signals (e.g., US signal) and receive signals (e.g., DS signal). The AFE unit 710 may further comprise analog components such as a line driver and pre-emphasis circuits for signal amplification, an analog-to-digital converter (ADC) for analog-to-digital conversion, and a digital-to-analog converter (DAC) for digital-to-analog conversion.

The DFE unit 720 is coupled to the AFE unit 710 and may comprise one or more DSPs and/or hardware logics configured to perform TDD frame synchronization, fast Fourier transform (FFT), inverse FFT (IFFT), received signal measurement, amplifier provisioning, diagnostic, spectral-shaping, signal conditioning, and other signal processing techniques similar to the signal processing techniques employed by an FTU-R such as the FTU-Rs 120, 420, and 520. TDD frame synchronization refers to the detection of a TDD frame such as the TDD frames 200 and 310. Depending on the amount of processing, the DFE unit 720 may buffer at least some TDD frames and may perform re-synchronization to conform to the G.fast TDD frame timing as shown in the TDD frame timing 300. When the DFE unit 720 performs FFT and/or IFFT, the processing delay may be about 2 DMT symbol time. The processing delay may be reduced to about 1.5 symbol time with more efficient hardware.

In a DS direction, the AFE unit 710 receives a DS signal from an FTU-O such as the FTU-Os 120, 410, and 510 via the first receive port 713 and sends the DS signal to the DFE unit 720 for signal amplification and signal conditioning. Subsequently, the AFE unit 710 receives the amplified and conditioned DS signal from the DFE unit 720 and transmits the amplified and conditioned DS signal to an FTU-R such as the FTU-Rs 120, 420, and 520 via the second transmit port 712.

In a US direction, the AFE unit 710 receives a US signal from an FTU-R via the second receive port 714 and sends the US signal to the DFE unit 720 for signal amplification and conditioning. Subsequently, the AFE unit 710 receives the amplified and conditioned US signal from the DFE unit 720 and transmits the amplified and conditioned US signal to an FTU-O via the first transmit port 711.

The amplifier 700 further comprises a POTS isolation unit 750 coupled to the first twisted pair line 731 and the second twisted pair line 732. The POTS isolation unit 750 may comprise a low frequency bypass circuit configured to isolate POTS signals from the US and DS signals. The POTS isolation unit 750 may be optional depending on the network configuration or the deployment scenario.

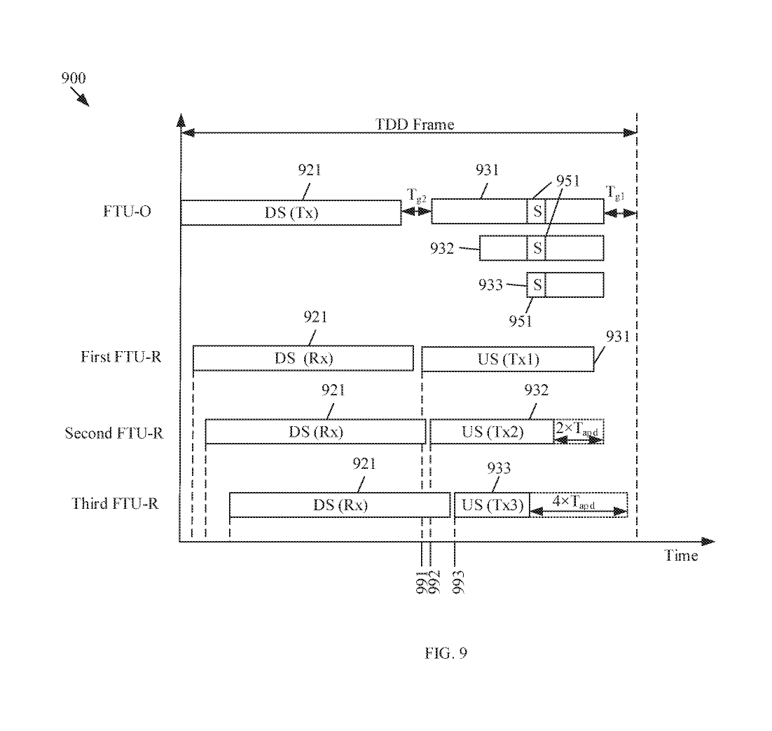

FIG. 8 is a timing diagram illustrating a regular transmission scheme 800 according to an embodiment of the disclosure. The scheme 800 is employed by the systems 400 and 500. For illustration purposes, the scheme 800 assumes a system with two cascade levels of amplifiers, where Na=2. The scheme 800 shows transmit and receive timings of a TDD frame 810 similar to the TDD frames 200 and 310 at a U-O interface such as the U-O interfaces 111 and 411 of an FTU-O, a U-R interface such as the U-R interfaces 121 and 421 of a first FTU-R, a U-R interface of a second FTU-R, and a U-R interface of a third FTU-R. For example, the FTU-O corresponds to the FTU-O 410. The first FTU-R corresponds to the FTU-R₁ 420 directly connected to the FTU-O 410. The second FTU-R corresponds to the FTU-R₂ 420 connected to the FTU-O 410 via the amplifier FA₁ 440. The third FTU-R corresponds to the FTU-R₃ 420 connected to the FTU-O 410 via the amplifiers FA₁ and FA₂ 440. As described above, the addition of amplifiers introduces delays into the transmission paths. Since FTU-Rs at different network segments such as the network segments 431 are connected to the FTU-O through different number of amplifiers, the FTU-Rs at different network segments experience different delays. In order to maintain synchronous transmission in the system, the scheme 800 equalizes or accounts for the amplifier delays by shortening and delaying US transmissions.

As an example, all amplifiers comprise the same delay, represented by T_{apd}, which includes both processing and propagation delays. Assuming transmissions begin with a DS transmission, the amplifier delay for n cascade amplifiers is n×T_{apd} in a DS direction and 2×n×T_{apd} in a US direction. Thus, a US burst such as the US burst 330 transmitted by a last-level FTU-R such as the FTU-R_{Na+1} 420 in a last network segment connected to the FTU-O via a maximum number of amplifiers, represented by Na, comprises the worst delay, which is 2×Na×T_{apd}. In order for the worst-delay US burst to be positioned within a US portion such as the US portion 213 and 313 of a TDD frame such as the TDD frames 200 and 310 at the FTU-O, the last-level FTU-R shortens the US burst by a duration of 2×Na×T_{apd} to account for the amplifier round trip delay of 2×Na×T_{apd}. As described above, certain signal processing techniques such as vectoring require all transmissions to be synchronous in the system. For example, US bursts transmitted by all FTU-Rs arrive at the FTU-O at the same time. In order to achieve synchronous transmission, all FTU-Rs shorten US bursts by a duration 2×Na×T_{apd} and each FTU-R delays transmission of each US burst by a duration of 2×(Na−k)×T_{apd}, where k represents the number of amplifiers positioned between the FTU-R and the FTU-O. Thus, all FTU-Rs delay US transmissions, except for the FTU-Rs at the last level.

In FIG. 8, the time duration for normal US transmissions without delay or shortening are shown as dotted boxes. At time 890, the FTU-O transmits a DS burst 821 similar to the DS bursts 320 and 340, shown as DS (Tx). At time 891, after a propagation delay of T_{pd}, the DS burst (Tx) 821 arrives at the first FTU-R, shown as DS (Rx1). At time 892, after an amplifier delay of T_{apd} of the first amplifier, the DS burst (Tx) 821 arrives at the second FTU-R, shown as DS (Rx2). At time 893, after an amplifier delay of T_{apd} of the second amplifier, the first DS burst (Tx) 821 arrives at the third FTU-R, shown as DS (Rx3).

At time 894, the third FTU-R transmits a shortened US burst 833, shown as US (Tx3). Since the third FTU-R is a last level FTU-R, the third FTU-R does not delay the transmission of the shortened US burst (Tx3) 833. At time 897, after a delay of 4×T_{apd}, the US burst (Tx3) 833 arrives at the FTU-O, shown as US (Rx3) 833.

At time 895, after delaying a duration of 2×T_{apd} from a normal US transmission time, the second FTU-R transmits a shortened US burst 832, shown as US (Tx2). At time 892, after a delay of 2×T_{apd}, the US burst (Tx2) 832 arrives at the FTU-O, shown as US (Rx2) 832.

At time 896, after delaying a duration of 4×T_{apd} from a normal US transmission, the first FTU-R transmits a shortened US burst 831, shown as US (Tx1). At time 897, after a propagation delay of T_{pd}, the US burst (Tx1) 831 arrives at the FTU-O, shown as US (Rx1) 831. As shown, by delaying the US transmission times at the first FTU-R and the second FTU-R, all the US burst (Rx1) 831, the US burst (Rx2) 832, and the US burst (Rx3) 833 arrive at the FTU-O at the same time 897.

Although the scheme 800 shortens US bursts, the amplification of US and DS signals increases data rates and/or coverage. For example, the data rates for the first FTU-R, the second FTU-R, and the third FTU-R are R, R/2, and R/4 before the addition of the first amplifier and the second amplifier, respectively. Assuming the TDD frame 810 comprises a total number of 36 symbols (e.g., M_{f}=36), the amplifier delay T_{apd} is 1.5 symbols, and the addition of each of the first amplifier and the second amplifier improves the data rate by a factor of 2. Then, the number of symbols in the TDD frame 810 available for carrying data is 29, where one symbol is consumed by guard intervals such as the DS-to-US gap times 212 and 312 and the US-to-DS gap times 214 and 314 and six symbols (e.g., 4×T_{apd}) are consumed by the two amplifiers. The following shows the data rate gain provided by the first amplifier and the second amplifier:

$$First FTU \text{-} R \text{:} [ ( \frac{29 Available symbols}{35 Total symbols} R - R ) \text{/} R ] \times 100 = - 17 percent ( \% )$$

$$Second FTU \text{-} R \text{:} [ ( \frac{29 Available symbols}{35 Total symbols} R - \frac{R}{2} ) \text{/} \frac{R}{2} ] \times 100 = 66 \%$$

$$Third FTU \text{-} R \text{:} [ ( \frac{29 Available symbols}{35 Total symbols} R - \frac{R}{4} ) \text{/} \frac{R}{4} ] \times 100 = 231 \% .$$

As shown, the first FTU-R comprises a data rate loss of about 17 percent (%), whereas the second FTU-R comprises a data rate gain of about 66% and the third FTU-R comprises a data rate gain of about 231%.

FIG. 9 is a timing diagram illustrating an efficient transmission scheme 900 according to an embodiment of the disclosure. The scheme 900 is employed by the systems 400 and 500. Unlike the scheme 800, the scheme 900 does not delay US transmissions and shortens the duration of US bursts as needed to maintain the TDD frame timing 300. For example, the reduction in US burst duration is dependent on the number of amplifiers between an FTU-R such as the FTU-Rs 420 and 520 and an FTU-O such as the FTU-Os 410, and 510. The scheme 900 shows transmit and receive timings at an FTU-O, a first FTU-R, a second FTU-R, and a third FTU-R in the 2-level cascade system. For example, the FTU-O corresponds to the FTU-O 410. Similar to the scheme 800, the first FTU-R corresponds to the FTU-R₁ 420 directly connected to the FTU-O 410. The second FTU-R corresponds to the FTU-R₂ 420 connected to the FTU-O 410 via the amplifier FA₁ 440. The third FTU-R corresponds to the FTU-R₃ 420 connected to the FTU-O 410 via the amplifiers FA₁ and FA₂ 440. The time duration for normal US transmissions without delay or shortening are shown as dotted boxes.

As shown, the transmission of the DS burst 921 is similar to the scheme 800. However, the first, second, and third FTU-Rs transmit US bursts 931, 932, and 933 without delaying the transmissions. In addition, the US bursts 931-933 are increasingly shortened as the number of amplifiers between an FTU-R and the FTU-O increases. For example, an FTU-R connected to the FTU-O via k number of amplifiers shortens its US bursts by a duration of 2×k×T_{apd} to account for the amplifier round trip delay. As shown, at time 993, the third FTU-R transmits a shortened US burst 933 without delaying the transmission, where the US burst 933 is shortened by a duration of 4×T_{apd} when compared to a normal burst duration as shown by the dotted box. After a delay of 4×T_{apd}, the shortened US burst 933 arrives at the FTU-O. At time 992, the second FTU-R transmits the shortened US burst 932 without delaying the transmission, where the US burst 932 is shortened by a duration of 2×T_{apd} when compared to a normal burst duration as shown by the dotted box. After a delay of 2×T_{apd}, the shortened US burst 932 arrives at the FTU-O. At time 992, the first FTU-R transmits a full US burst 931 without delaying the transmission. After a propagation delay of T_{pd}, the US burst 931 arrives at the FTU-O.

Since the first FTU-R, the second FTU-R, and the third FTU-R transmit the US bursts 931-933 without delays, the US bursts 931-933 arrive at the FTU-O at different times. In order to enable the FTU-O to perform synchronous signal processing such as vectoring, the first FTU-R, the second FTU-R, and the third FTU-R adjust the positions of the S symbols 951 so that the S symbols 951 of the US bursts 931-933 are aligned in time at the FTU-O.

The scheme 900 is more efficient than the scheme 800 since the scheme 900 removes the delay requirements at the FTU-Rs during US transmissions. For example, in the scheme 900, the first FTU-R directly connected to the FTU-O maintains the same data throughput without penalty from the addition of amplifiers as in the scheme 800. The second FTU-R connected to the FTU-O via one amplifier comprises a data rate gain of about 83% instead of about 66% as in the scheme 800. The third FTU-R connected to the FTU-O via two amplifiers comprises the same data rate gain of about 231% as in the scheme 800.

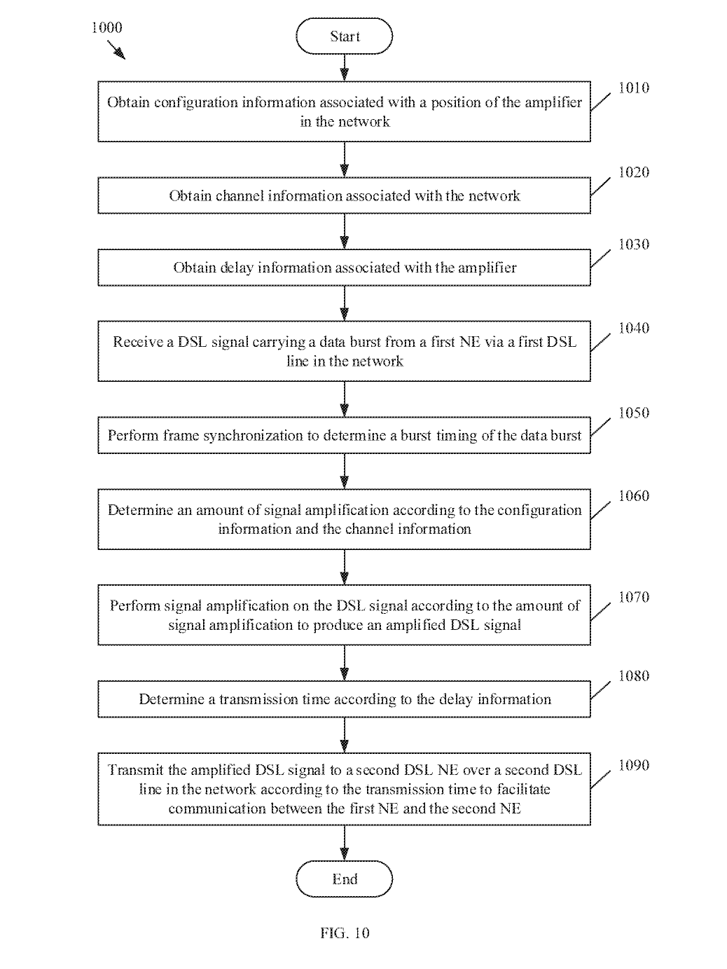

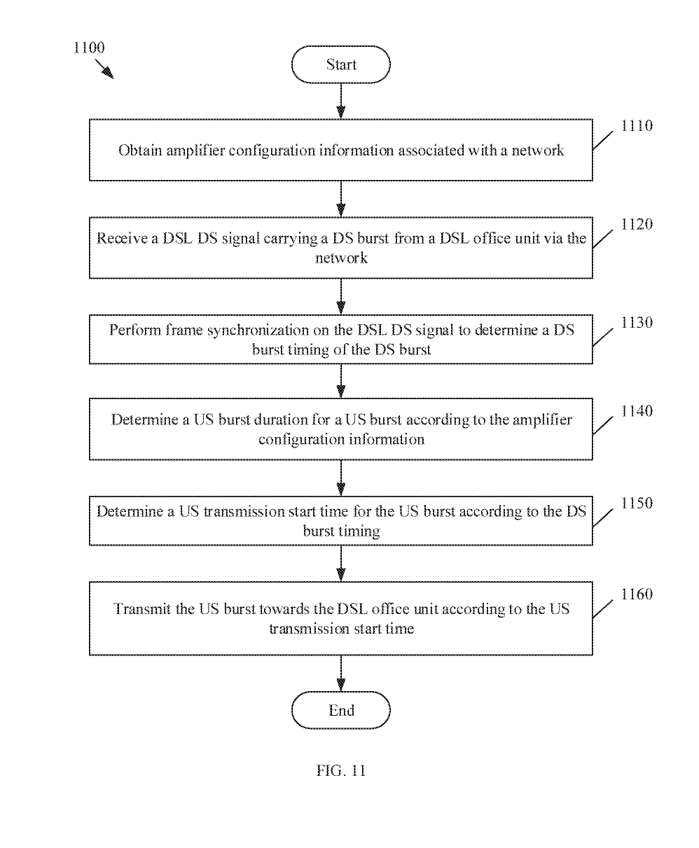

FIG. 10 is a flowchart of a signal amplification method 1000 according to an embodiment of the disclosure. The method 1000 is implemented by an amplifier, such as the amplifiers 440, 540, and 700 and the NE 600, to extend the coverage of a G.fast network such as the systems 400 and 500. The method 1000 is implemented when the amplifier receives a signal from an FTU-O such as the FTU-O 110, 410, and 510, an FTU-R such as the FTU-R 420 and 520, or another amplifier in the network. The FTU-O and the FTU-R may employ the scheme 800 or 900. A step 1010, configuration information associated with a position of the amplifier in the network is obtained. For example, the configuration information indicates a network segment such as the network segments 431 where the amplifier is positioned. At step 1020, channel information associated with the network is obtained, for example, by measuring and analyzing channels in the network. At step 1030, delay information associated with the amplifier is obtained. For example, the delay information may include processing delay and propagation delay of the amplifier such as T_{apd} described in the schemes 800 and 900.

At step 1040, a DSL signal carrying a data burst such as the DS bursts 320, 821 and 921 and the US bursts 330, 831-833, and 931-933 is received from a first NE via a first DSL line such as the twisted pair lines 130, 430, 530, 731, and 732 in the network. The first NE may be an FTU-O or an FTU-R. At step 1050, frame synchronization is performed to determine a burst timing of the data burst, where the burst timing may include a start time and an end time of the data burst. At step 1060, an amount of signal amplification is determined according to the configuration information and the channel information. At step 1070, signal amplification is performed on the DSL signal according to the amount of signal amplification to produce an amplified DSL signal. At step 1080, a transmission time is determined according to the delay information. At step 1090, the amplified DSL signal is transmitted to a second NE over a second DSL line in the network according to the transmission time to facilitate communication between the first NE and the second NE. When the first NE is an FTU-O, the second NE is an FTU-R. Conversely, when the first NE is an FTU-R, the second NE is an FTU-O.

FIG. 11 is a flowchart of a US transmission method 1100 according to an embodiment of the disclosure. The method 1100 is implemented by an FTU-R such as the FTU-Rs 420 and 520 and the NE 600 in a G.fast network such as the systems 400 and 500. The method 1100 is implemented when the FTU-R performs US transmission when amplifiers such as the amplifiers 440, 540, and 700 are positioned in the network. The method 1100 employs similar mechanisms as described in the scheme 800 and 900. At step 1110, amplifier configuration information associated with the network is obtained. For example, the amplifier configuration indicates a first number of amplifiers (e.g., Na) along a DS transmission path with a maximum number of amplifiers, a second number of amplifiers (e.g., k) positioned between an FTU-O such as the FTU-Os 410 and 510 and the FTU-R, and an amplifier delay (e.g., N_{apd}) associated with the amplifiers. At step 1120, a DSL DS signal carrying a DS burst, such as the DS bursts 320, 821, and 921, is received from a DSL office unit such as the FTU-O 410 and 510 via the network. At step 1130, frame synchronization is performed on the DSL DS signal to determine a DS burst timing of the DS burst. The DS burst timing may include a time when the DS burst is received. At step 1140, a US burst duration is determined for a US burst such as the US bursts 330, 831-833, and 931-933 according to the amplifier configuration information. At step 1150, a US transmission start time is determined for the US burst according to the DS burst timing. The US burst duration and US transmission start time are determined according to the scheme 800 or 900. At step 1160, the US burst is transmitted towards the DSL office unit according to the US transmission start time.

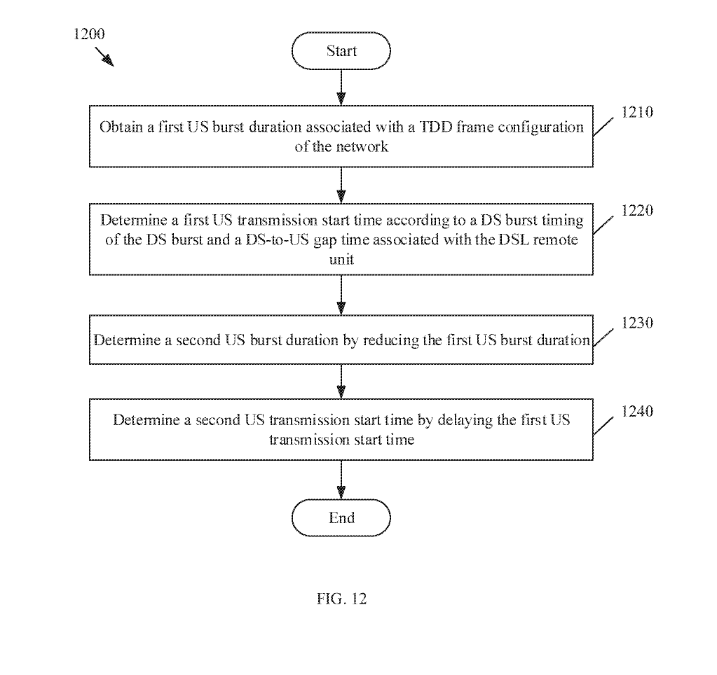

FIG. 12 is a flowchart of a US transmission method 1200 according to another embodiment of the disclosure. The method 1200 is implemented by an FTU-R such as the FTU-Rs 420 and 520 and the NE 600 in a G.fast network such as the systems 400 and 500. The method 1200 is utilized during the steps 1140 and 1150 of method 1110 after a DS burst such as the DS bursts 320, 821, and 921 has been received. The method 1200 employs the scheme 800 to adjust US transmission start time and durations. At step 1210, a first US burst duration associated with a TDD frame configuration of the network is obtained. The TDD frame configuration is similar to the structure of the TDD frames 200 and 310. The first US burst duration corresponds to Mᵤₛ×T_{symb}, where Mᵤₛ represents the number of symbols in a US portion such as the US portions 213 and 313 of the TDD frame and T_{symb} represents a DMT symbol time. At step 1220, a first US transmission start time is determined according to a DS burst timing of the DS burst and a DS-to-US gap time (e.g., T_{g1′}) associated with the FTU-R. The DS burst timing includes a completion time when the reception of the DS burst is completed at a U-R interface such as the U-R interfaces 121 and 421 of the FTU-R. The first US transmission start time is computed by adding the DS-to-US gap time to the completion time. At step 1230, a second US burst duration is determined by reducing the first US duration by a first duration of 2×Na×T_{apd}. At step 1240, a second US transmission start time is determined by delaying the first US transmission start time by a second duration of 2×(Na−k)×T_{apd}. The Na represents the number of amplifiers such as the amplifiers 440, 540, and 700 positioned along a transmission path with the maximum number of amplifiers. The k represents the number of amplifiers positioned between an FTU-O such as the FTU-Os 410 and 510 and FTU-R. The T_{apd} represents an amplifier delay associated with the amplifiers.

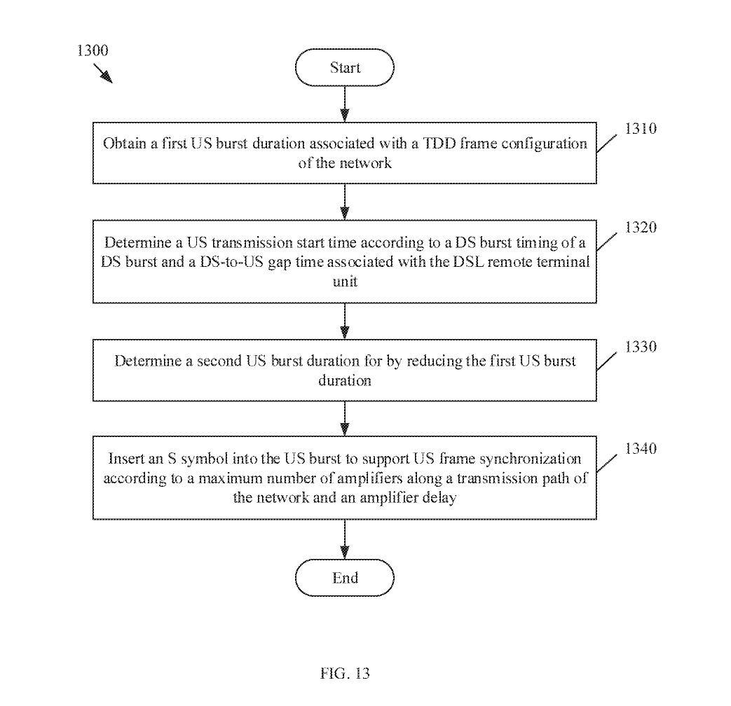

FIG. 13 is a flowchart of a US transmission method 1300 according to another embodiment of the disclosure. The method 1300 is implemented by an FTU-R such as the FTU-Rs 420 and 520 and the NE 600 in a G.fast network such as the systems 400 and 500. The method 1300 is utilized during the steps 1140 and 1150 of method 1110 after a DS burst such as the DS bursts 320, 821, and 921 has been received. The method 1300 employs the scheme 900 to adjust US transmission start time and durations. At step 1310, a first US burst duration associated with a TDD frame configuration of the network is obtained similar to the step 1210. At step 1320, a first US transmission start time is determined according to a DS burst timing of the DS burst and a DS-to-US gap time associated with the DSL remote unit similar to the step 1220. At step 1330, a second US burst duration is determined by reducing the first US duration by a first duration of 2×k×T_{apd}. The k represents the number of amplifiers such as the amplifiers 440, 540, and 700, positioned between an FTU-O such as the FTU-Os 410 and 510 and the FTU-R. The T_{apd} represents an amplifier delay associated with the amplifiers. At step 1340, an S symbol such as the S symbol 951 is inserted into the US burst to support US frame synchronization according to the number of amplifiers along a transmission path with the maximum number of amplifiers (e.g., Na) and the amplifier delay (e.g., T_{apd}) so that the S symbol is transmitted at a time of at least 2×(Na−k)×T_{apd} after the first US transmission start time.

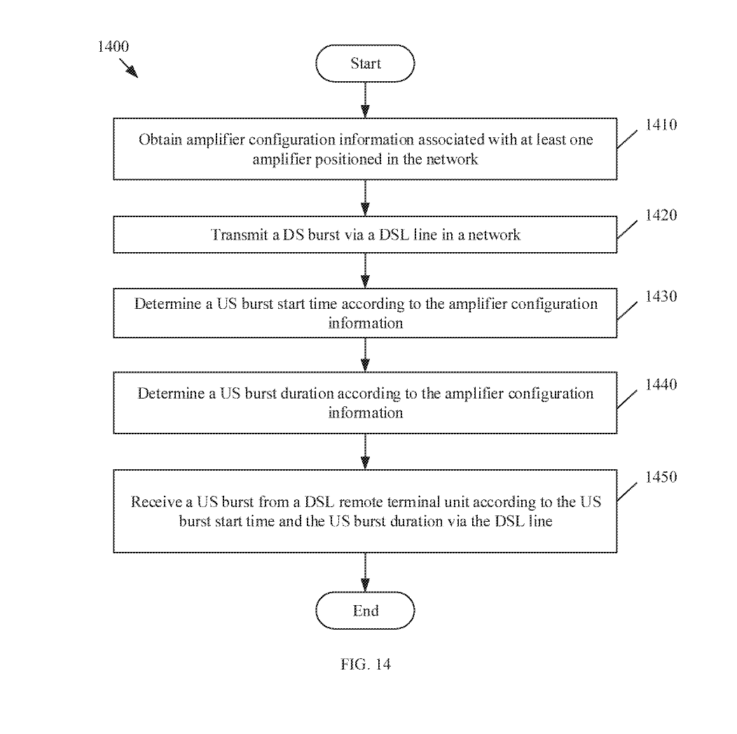

FIG. 14 is a flowchart of a US reception method 1400 according to an embodiment of the disclosure. The method 1100 is implemented by an FTU-O such as the FTU-Os 410 and 510 and the NE 600 in a G.fast network, such as the systems 400 and 500. The method 1400 is utilized when the FTU-O performs US reception when amplifiers such as the amplifiers 440, 540, and 700 are positioned in the network. The method 1400 employs similar mechanisms as described in the scheme 800 and 900. At step 1410, amplifier configuration information associated with at least one amplifier positioned in the network is obtained. For example, the amplifier configuration information indicates a first number of amplifiers (e.g., Na) along a DS transmission path with a maximum number of amplifiers, a second number of amplifiers (e.g., k) positioned between the FTU-O and FTU-Rs such as the FTU-Rs 420 and 520, and an amplifier delay (e.g., N_{apd}) associated with the amplifiers. At step 1420, a DS burst such as the DS bursts 320, 821, and 921 is transmitted via a DSL line such as the twisted pair lines 130, 430, 530, 731, and 732 in the network. At step 1430, a US burst start time is determined according to the amplifier configuration information. At step 1440, a US burst duration is determined according to the amplifier configuration information. For example, the schemes 800 and 900 are used to determine the US burst duration and the US burst start time. At step 1450, a US burst such as the US bursts 330, 831-833, and 931-933 is received from a DSL remote terminal unit according to the US burst start time and the US burst duration via the DSL line.

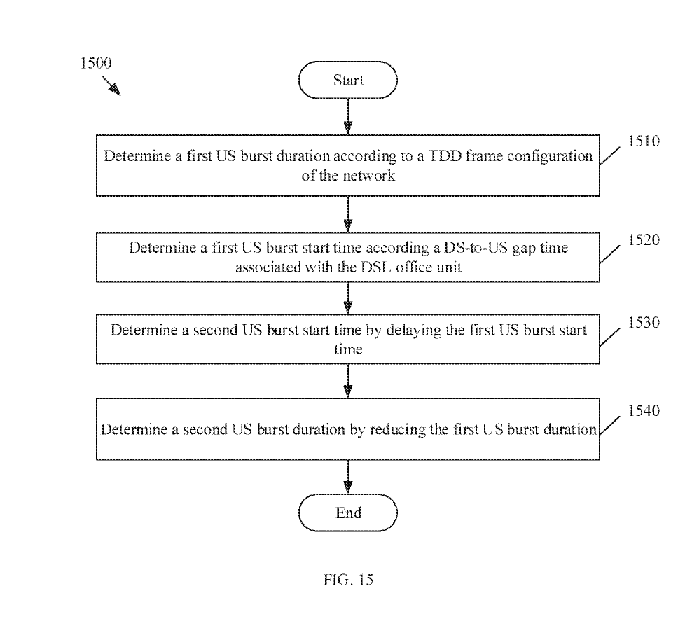

FIG. 15 is a flowchart of a US reception method 1500 according to another embodiment of the disclosure. The method 1500 is implemented by an FTU-O such as the FTU-Os 410 and 510 and the NE 600 in a G.fast network such as the systems 400 and 500. The method 1500 is utilized during the steps 1430 and 1440 of method 1400 after a DS burst such as the DS bursts 320, 821, and 921 has been transmitted. The method 1500 employs the schemes 800 and 900 to adjust US reception time and duration. At step 1510, a first US burst duration is determined according to a TDD frame configuration of the network. The TDD frame configuration is similar to the structures of the TDD frames 200 and 310. The first US burst duration corresponds to Mᵤₛ×T_{symb}, where Mᵤₛ represents the number of symbols in a US portion such as the US portions 213 and 313 of the TDD frame and T_{symb} represents a DMT symbol time. At step 1520, a first US burst start time is determined according to a DS-to-US gap time associated with the FTU-O (e.g., T_{g2}) at an U-O interface such as the U-O interfaces 111 and 411. The first US burst start time is computed by adding the DS-to-US gap time to the transmission completion time of a DS burst such as the DS bursts 320, 821, and 921. At step 1530, a second US burst start time is determined by delaying the first US burst start time according to the scheme 800 or 900. At step 1540, a second US burst duration is determined by reducing the first US burst duration according to the scheme 800 or 900. For example, when employing scheme 800, the US burst start time is delayed by a duration of 2×(Na−k)×T_{apd} and the US burst duration is reduced by a duration of 2×Na×T_{apd}. Alternatively, when employing the scheme 900, the US burst start time is delayed by a duration of 2×k×T_{apd} and the US burst duration is reduced by a duration of 2×k×T_{apd}.

In an embodiment, additional handshakes or message exchanges are added to the G.fast standard to facilitate the transmission schemes 800 and 900 as described in the U.S. Provisional Patent Application 62/121,837. The additional handshakes or message exchanges may include discovery, activation, and management of amplifiers such as the amplifiers 440, 540, and 700 in a G.fast network such as the systems 400 and 500. For example, an FTU-O such as the FTU-Os 410 and 510 and amplifiers may exchange amplifier configuration information during an initialization stage prior to a normal operation or a showtime stage. The amplifier configuration information may include the configuration or the architecture of the amplifiers in the network such as a cascade configuration as shown in the system 400 or a tree configuration as shown in the system 500 and the number of amplifiers along each transmission path in the network. In addition, the amplifier configuration information may include delays of the amplifiers such as T_{apd}. Subsequently, the FTU-O may provide FTU-Rs such as the FTU-Rs 420 and 520 with the amplifier configuration information to enable the FTU-Rs to shorten US burst duration and/or delay US transmission start time as described in the schemes 800 and 900.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed is:

1. An apparatus comprising:
a receiver configured to receive a digital subscriber line (DSL) signal carrying a data burst from a first network element (NE) via a first DSL line in a network;
a processor coupled to the receiver and configured to:
perform frame synchronization to determine a burst timing of the data burst;
perform signal amplification on the DSL signal to produce an amplified DSL signal; and
determine a transmission time for the amplified DSL signal according to the burst timing of the data burst; and
a transmitter coupled to the processor configured to transmit the amplified DSL signal to a second NE over a second DSL line in the network according to the transmission time to facilitate communication between the first NE and the second NE.

2. The apparatus of claim 1, wherein the burst timing is associated with a time-domain duplexing (TDD) frame timing of the network.

3. The apparatus of claim 1, wherein the processor is further configured to:
obtain configuration information associated with a position of the apparatus in the network;
obtain channel information associated with the network:
determine an amount of signal amplification according to the configuration information and the channel information; and
perform the signal amplification on the DSL signal according to the amount of signal amplification.

4. The apparatus of claim 1, wherein the processor is further configured to:
obtain delay information associated with the apparatus; and
determine the transmission time according to the delay information.

5. The apparatus of claim 1, wherein the processor is further configured to perform signal conditioning on the DSL signal, and wherein the signal conditioning comprises spectral-shaping.

6. The apparatus of claim 1, wherein the apparatus is an amplifier positioned along a downstream (DS) transmission path of the network, and wherein the network is a fast access to subscriber terminals (G.fast) network.

7. The apparatus of claim 1, wherein the apparatus is an amplifier positioned along an upstream (US) transmission path of the network, and wherein the network is a fast access to subscriber terminals (G.fast) network.

8. The apparatus of claim 1, wherein the apparatus is an amplifier, and wherein at least one of the first NE and the second NE is another amplifier.

9. A digital subscriber line (DSL) remote terminal unit, comprising:
a receiver configured to receive a DSL downstream (DS) signal carrying a DS burst from a DSL office unit via a network;
a processor coupled to the receiver and configured to:
obtain amplifier configuration information associated with at least one amplifier positioned in the network;
perform frame synchronization on the DSL DS signal to determine a DS burst timing of the DS burst;
determine a first upstream (US) burst duration for a US burst according to the amplifier configuration information; and
determine a first US transmission start time for the US burst according to the DS burst timing; and
a transmitter coupled to the processor and configured to transmit the US burst towards the DSL office unit according to the first US transmission start time.

10. The DSL remote terminal unit of claim 9, wherein the amplifier configuration information indicates:
a first number of amplifiers along a DS transmission path with a maximum number of amplifiers, wherein Na represents the first number of amplifiers;
a second number of amplifiers positioned between the DSL office unit and the DSL remote terminal unit, wherein k represents the second number of amplifiers; and
an amplifier delay associated with the amplifiers, wherein T_{apd} represents the amplifier delay.

11. The DSL remote terminal unit of claim 10, wherein the processor is further configured to:
obtain a second US burst duration associated with a time-domain duplexing (TDD) frame configuration of the network;
determine a second US transmission start time according to the DS burst timing and a DS-to-US gap time associated with the DSL remote terminal unit;
determine the first US burst duration by reducing the second US burst duration by a first duration of 2×Na×T_{apd}; and
determine the first US transmission start time by delaying the second US transmission start time by a second duration of 2×(Na−k)×T_{apd}.

12. The DSL remote terminal unit of claim 10, wherein the processor is further configured to:
obtain a second US burst duration associated with a time-domain duplexing (TDD) frame configuration of the network;
determine the first US burst duration for the US burst by reducing the second US burst duration by a first duration of 2×k×T_{apd};
determine the first US transmission start time according to the DS burst timing and a DS-to-US gap time associated with the DSL remote terminal unit; and
insert a synchronization (S) symbol into the US burst to support US frame synchronization according to Na and T_{apd} so that the S symbol is transmitted at a time of at least 2×(Na−k)×T_{apd} after the first US transmission start time.

13. The DSL remote terminal unit of claim 9, wherein the network is a fast access to subscriber terminals (G.fast) network, wherein the DSL remote terminal unit is a G.fast transceiver unit at a remote terminal side (FTU-R), and wherein the DSL office unit is a G.fast transceiver unit at an office side (FTU-O).

14. A digital subscriber line (DSL) office unit, comprising:
a transmitter configured to transmit a DSL downstream (DS) burst via a first DSL line in a network;
a processor coupled to the transmitter and configured to:
obtain amplifier configuration information associated with at least one amplifier positioned in the network;
determine a first upstream (US) burst start time according to the amplifier configuration information; and
determine a first US burst duration according to the amplifier configuration information; and
a receiver coupled to the processor and configured to receive a first US burst from a first DSL remote terminal unit according to the first US burst start time and the first US burst duration via the first DSL line.

15. The DSL office unit of claim 14, wherein the amplifier configuration information indicates:
a first number of amplifiers along a DS transmission path with a maximum number of amplifiers, wherein Na represents the first number of amplifiers;
a second number of amplifiers positioned between the DSL office unit and the first DSL remote terminal unit, wherein k represents the second number of amplifiers; and
an amplifier delay associated with the amplifiers, wherein T_{apd} represents the amplifier delay.

16. The DSL office unit of claim 15, wherein the processor is further configured to:
determine a second US burst duration according to a time-domain duplexing (TDD) frame configuration of the network;
determine a second US burst start time according to a DS-to-US gap time associated with the DSL office unit;
determine the first US burst start time by delaying the second US burst start time by a first duration of 2×Na×T_{apd}; and
determine the first US burst duration by reducing the second US burst duration by a second duration of 2×Na×T_{apd}.

17. The DSL office unit of claim 15, wherein the processor is further configured to:
determine a second US burst duration according to a time-domain duplexing (TDD) frame configuration of the network;
determine a second US burst start time according to a DS-to-US gap time associated with the DSL office unit;
determine the first US burst start time by delaying the second US burst start time by a first duration of 2×k×T_{apd}; and
determine the first US burst duration by reducing the second US burst duration by a second duration of 2×k×T_{apd}.

18. The DSL office unit of claim 17, wherein the processor is further configured to:
determine a third US burst start time according to the amplifier configuration information, wherein the third US burst start time is different from the first US burst start time; and
determine a third US burst duration according to the amplifier configuration information, wherein the third US burst duration is different from the first US burst duration;
wherein the receiver is further configured to receive a second US burst from a second DSL remote terminal unit according to the third US burst start time and the third US burst duration via a second DSL line in the network.

19. The DSL office unit of claim 18, wherein the first US burst comprises a first synchronization (S) symbol, wherein the second US burst comprises a second S symbol, and wherein the first S symbol and the second S symbol are received at about the same time.

20. The DSL office unit of claim 14, wherein the network is a fast access to subscriber terminals (G.fast) network, wherein the DSL office unit is a G.fast transceiver unit at an office side (FTU-O), and wherein the DSL remote terminal unit is a G.fast transceiver unit at a remote terminal side (FTU-R).
